(19) United States
(12) Patent Application Publication
(10) Pub. No.: US 2006/0153148 A1
(43) Pub. Date: Jul. 13, 2006

(54) Method for wlan exclusive downlink channel

(76) Inventors: Guillaume Bichot, La Chapelle Chaussee (FR); Charles Wang, Jamison, PA (US)

Correspondence Address: THOMSON LICENSING INC., PATENT OPERATIONS, PO BOX 5312, PRINCETON, NJ, 08543-5312, US

(21) Appl. No.: 10/545,244

(22) PCT Filed: Feb. 27, 2004
(86) PCT No.: PCT/US04/06193

§ 371 Date: Aug. 12, 2005

Related U.S. Application Data
(60) Provisional application No. 60/450,912, filed on Feb. 28, 2003.

(51) Int. Cl. H04Q 7/24

(52) U.S. Cl. 370/338

(57) ABSTRACT

A wireless local area network (WLAN) adheres to ANSI/IEEE 802.11 standards and communicates with user terminals (UTs) in a coverage region. The WLAN communicates video and audio to the mobile terminals over a downlink channel. In order to maximize quality of service, the system provides for a method of inhibiting the mobiles terminals from attempting to gain control of the downlink channel during transmission of program information. In particular, the WLAN access point transmits data frames that are separated in inter-frame time period that is shorter than a first inter-frame period defined by the communications standard for allowing a device to gain control of the transmission channel.

### FIELD OF THE INVENTION

This invention relates to the communication of video or audio streams to mobile user terminals or stations by way of Wireless Local Area Networks (WLANs), and more particularly to controlling the quality of service in the presence of breaks in the streaming information.

### BACKGROUND OF THE INVENTION

Wireless Local Area Networks (WLANs) are popular because they are inexpensive and provide remote Internet access with high bandwidth and in a convenient manner. Such WLANs are provided in “hotspot” regions where there is substantial traffic of potential users, such as airports, shopping malls, coffee shops, and the like. FIG. 1 is a simplified block diagram of a system 10 including a wireless local area network with a single representative user terminal or station in the coverage area 31. As illustrated in FIG. 1, the Wireless Local Area Network is represented by a block 12. WLAN 12 communicates with a plurality of user terminals (UT), or mobile terminal (MT), one of which is designated 14, which lie within its coverage region. The communication is by way of electromagnetic radiation, illustrated by symbol 16. In order for the WLAN 12 to interact properly with all the user terminals which may enter its coverage region, both the WLAN and the user terminals must adhere to common standards. Among the standards that may be used by equipment manufacturers are the IEEE 802.11 standards, which specify many aspects of the interoperation of the elements.

A channel is identified in IEEE 802.11 by its frequency, regardless of the physical layer. IEEE 802.11b provides for higher data rates within a channel with the aid of Direct Sequence Spread-Spectrum coding for reduced interference. In such usage, only a limited number of channels are available, such as three non-overlapping channels in the case of IEEE 802.11b in the U.S. Each mobile user terminal that enters the coverage region of the WLAN must contend with other users in order to gain access to a channel for two-way communication. The IEEE 802.11 standards provide several mechanisms that aid in allowing a user terminal to gain access to or “grab” a channel. Among these are specifications for two different Medium Access Control (MAC) modes. The default mode is the Distributed Coordination Function (DCF), and it is always available in a user terminal. An optional mode that may be used under IEEE 802.11 is the Point Coordination Function (PCF). The PCF mode provides for implementation of Quality-of-Service (QoS) functions, which provide for preferential treatment of certain types of data under network congestion conditions. The PCF mode requires extra software or firmware in the equipment over and above that required by DCF mode. Since the PCF mode is optional and requires more software/firmware, one cannot be certain that a user terminal will be fitted for this mode.

The Distributed Coordination Function (DCF) does not provide quality-of-service (QoS) functions. In normal operation of the DCF-equipped user terminals in the coverage region of a wireless local area network (WLAN), each terminal attempts to acquire the channel. This attempt to gain control of the channel may occur during the time that another user is making use of the channel, and may result in simultaneous transmission of information from two or more entities, which can result in failure to receive either piece of information (packet collision).

The MAC modes provided by the protocols established by IEEE 802.11 are intended to reduce or eliminate the potential for collisions. This is accomplished by having each terminal that wishes to gain control of the channel maintain a Network Allocation Vector (NAV). The NAV information is constantly updated by each user terminal based on “Duration” information transmitted by the access point of the wireless local area network in the header of data and management frames transmitted thereby. The Duration information relates to the time at which the transaction is complete. When the current data and/or management transaction is complete, at the time specified by the NAV, each terminal can then attempt to gain control of the channel. In this scenario, since all the terminals wait until the transaction is finished before attempting to gain control of the channel, there is little loss of data in the process of being transmitted.

The channel acquisition process set forth above is not totally secure, because a terminal could ignore the duration information in the frame header and acquire the channel during those intervals in which the access point is not transmitting frames.

The owner of a wireless local area network (WLAN) may wish to attract more customers to his enterprise by providing additional value, thereby attracting more revenue. One way to add value to his WLAN would be by provision of digitally compressed video (with appurtenant audio) broadcast by one or more channels of the LAN. If the quality of the broadcast video is poor, the added value may be less than intended. The best video service or highest Quality of Service (QoS), including best bandwidth, delay time and potential for packet loss, is achieved by limiting the contention on the video channel. Limiting the contention might be achieved by the use of the Point Coordination Function (PCF) mentioned above. However, one cannot be certain that all the user terminals will be fitted for QoS operation with PCF.

Improved or alternative apparatus and method are desired for providing reduced- or no-contention operation while operating in the DCF mode described above.

### SUMMARY OF THE INVENTION

A method for broadcasting information, in particular audio/video program data, comprises the steps of procuring sequential frames of the information to be broadcast, and coupling the sequential frames of the information to a medium. In an advantageous mode of the method, the medium includes a frequency channel of a wireless local area network. The transmission system comprises an access point of a local area network conforming to communication standards promulgated by a standards body. The information is transmitted to a coverage region over a dedicated medium. The medium is shared, and access to the medium is based on carrier sense multiple access. The information is received at a user terminal located in the coverage region and compliant with the communication standards. As a result, during intervals in which the length of time between transmitted frames exceeds a predetermined time period, such as an Inter-Frame Space pursuant to the communication standards, the user terminal are permitted to attempt to gain control of the channel. Frames are continuously broadcast from the access point and on the channel, with the transmission of the frames having inter-frame times, which are shorter than the Inter-Frame Spacing pursuant to the communication standards. This inhibits the user terminal from attempting to gain control of the channel medium, thereby allowing the broadcast of the information takes place without contention for control of the channel. This method is particularly advantageous when transmitting audio/video program information in which the information must be transmitted at a particular rate without interruptions.

A method for broadcasting information according to an aspect of the invention includes the steps of procuring sequential frames of the information and coupling the information to a transmission system comprising an access point of a wireless local area network conforming to communication standards promulgated by a standards body. The information is transmitted to a coverage region over a dedicated frequency band channel of the access point. The medium is shared, and access to the medium is based on carrier sense multiple access. The information is received over the dedicated channel at a user terminal, also compliant with the communication standards, and which is located in the coverage region. As a result, the user terminal may attempt to gain control of the channel during intervals in which the length of time between transmitted frames of information exceeds an Inter-Frame Space according to the communication standards. Frames are continuously transmitted from the at least one access point, and on the channel, with inter-frame gaps which are shorter than the Inter-Frame Space according to the communication standards, whereby the user terminal is inhibited from attempting to gain control of the channel and broadcasting of the information occurs without contention for control of the channel.

In an exemplary embodiment of the method, the frames are transmitted by an access point operating in the DCF mode according to the IEEE 802.11 standards and the step of continuously transmitting frames includes the step of transmitting the frames with temporal spacing which is one of (a) Short Inter-Frame Space (SFIS) and (b) Point Inter-Frame Space (PIFS) as set forth in IEEE 802.11 communication standards. The step of procuring information may include procuring at least one of audio and video information, and preferably both.

### BRIEF DESCRIPTION OF THE DRAWING

FIG. 1 is a simplified representation of a prior-art WLAN communication system;

FIG. 2 is a simplified diagram of a WLAN system according to an aspect of the invention;

FIG. 3 is a time line illustrating certain time intervals set forth in communication standards; and

FIG. 4 is a time line illustrating a possible scenario of transmission of video and audio frames with time spacings set forth in FIG. 3, and the transmission of dummy frames when information frames are not available.

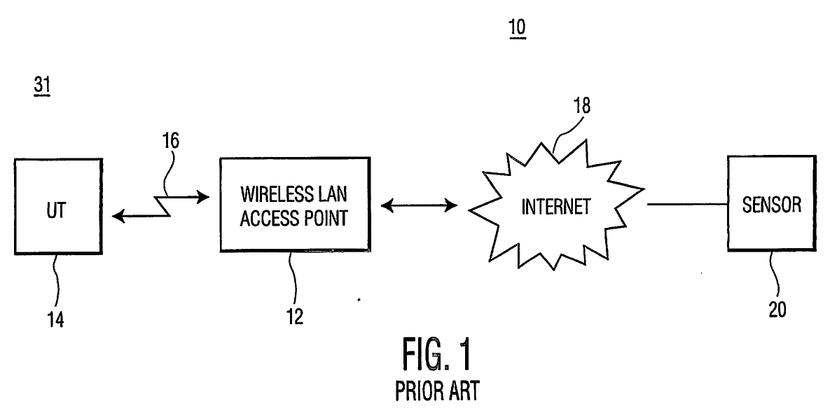

### DESCRIPTION OF THE INVENTION

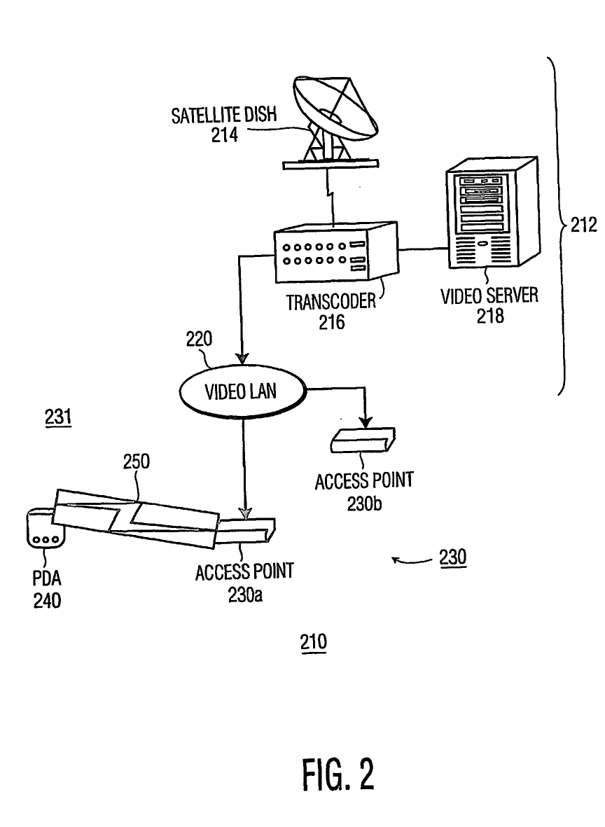

FIG. 2 represents a wireless local area network (WLAN) 210 arranged for transmission of video information (with associated audio) according to an aspect of the invention. In FIG. 2, a video network designated generally as 212 includes a satellite dish 214, a transcoder 216, a video server 218, and a video local area network (LAN) 220. The satellite dish 214 receives one or more channels of video (with appurtenant audio) from a satellite (not illustrated) and makes the information available to transcoder 216. Transcoder 216 converts the satellite video into a compressed format that can be received and processed by a user terminal, such as PDA 240. The compressed or transcoded video may be made available to a video server for storage, and is also made available to video LAN 220 for distribution. Other sources of video are possible, including local storage of video in video server 218, or a terrestrial antenna, or a cable television system, or simply a video playback arrangement such as a VCR or DVD player.

The compressed video from transcoder 216 is coupled by video LAN 220 to one or more (two illustrated) Wireless LAN (WLAN) access points 230a, 230b. The access points operate in accordance with the IEEE 802.11 standards. Each of access points 230a and 230b communicate with mobile user terminals (one illustrated, designated PDA 240) lying within the coverage area 231 of the WLAN(s). The communication between a user terminal and a WLAN access point is illustrated in FIG. 2 by symbol 250. As mentioned, it may be desirable to disable at least part of the channel grabbing ability of those user terminals operating in the coverage region of the WLAN, so that they do not try to acquire the channel on which video is being broadcast.

According to an aspect of the invention, the access point, for example access point 230a, is made to appear to be busy at all times, at least on the channel(s) on which the video is broadcast. This is accomplished in conformance with ANSI/IEEE Std. 802.11, 1999 Edition, part 11: Wireless LAN Medium Access Control (MAC) and Physical Layer (PHY) specifications. More particularly, according to the ANSI/IEEE standard a user terminal or station that wants to acquire a channel listens to the medium and, if it detects a silence (no carrier) for a duration known as a Distributed Inter-Frame Space (DIFS), is permitted to attempt access. This is known as carrier sense multiple access (CSMA). The user terminal, according to the standard, should not attempt access within a time after the end of a carrier which is less or shorter than the DIFS. In accordance with the present invention, the access point 230a of FIG. 2 is made to appear to be continuously busy to all user terminals 240 in its coverage region by continuously transmitting frames with an inter-frame spacing that is less than the DIFS. The access point 230a may be programmed, in a manner known to those skilled in the art, to transmit the frames in this manner when the received from the LAN 220 is indicated to correspond to an audio/video program data that requires transmission at a particular rate without interruption. Such indicative data may be, for example, transmitted with the transcoded audio/video data. The access point may also be programmed to transmit the frames in this manner in response to the source of the data, for example, transcoder 216.

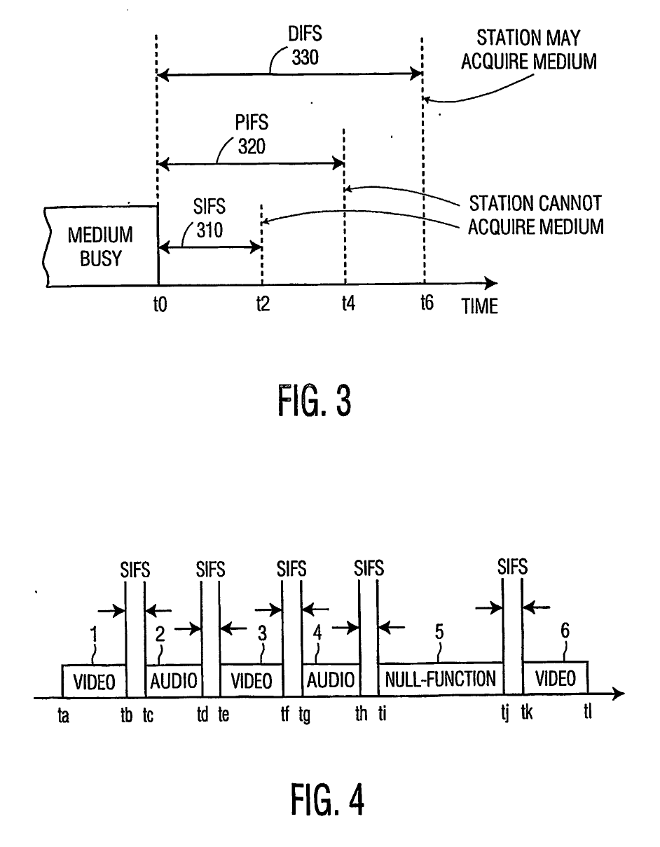

In the time line of FIG. 3, the transmission of data on the channel is illustrated by “Medium Busy” from an indeterminate earlier time until a time t0. The ANSI/IEEE standards provide for two inter-frame durations or temporal spacings following end-of-transmission time t0 which are less than the DIFS. These are the Short Inter-Frame Space (SIFS) 310, ending at time t2 of FIG. 3, and the Point Inter-Frame Space (PIFS) 320 ending at time t4 of FIG. 3. The timing of the DIFS relative to the SIFS and the PIFS is illustrated by DIFS 330 of FIG. 3, ending at a time designated t6. The user terminal or station 240 of FIG. 2 is not permitted to, or cannot, pursuant to the standards, attempt to acquire the channel medium at a time following end-of-transmission time t0 that is less than the DIFS 330 time t6. According to the IEEE 802.11 standards, the DIFS are to be used by a station operating in the DCF mode, which is the default mode of operation. The PIFS are to be used in the PIFS mode. The SIFS are used for an ACK frame, a clear to send (CTS) frame, and the second or subsequent data frames of a fragment burst. Thus, in normal operation, the DIFS is to be used rather than the SIFS or the PIFS. Using this method, the other mobile stations within the WLAN need not access or read the PCF information in the beacon message to allow the access point to maintain control of the transmission channel while broadcasting the sequence of A/V frames.

According to an aspect of the invention, one of the SIFS and PIFS is used as the inter-frame time between successive downlink transmissions by the access point 230a of FIG. 2 while transmitting data frames of an audio/video program in the DCF mode of operation. If no video or audio data frame is present, the access point transmits a dummy frame according to the abovedescribed ANSI/IEEE standards. Null frame data may also be stuffed into the audio/video data frames to maintain the desired timing between the frames, i.e., less than the DIFS. More particularly, the “frame type” is set to equal “data” and the “frame sub-type” is set to equal “Null Function” in the absence of an actual data frame. This type of dummy frame is ignored by the receiving station, which in this case corresponds to the user terminal 240 of FIG. 2.

FIG. 4 illustrates one possible frame structure transmitted by the access point 230a of FIG. 2 in the case of an exclusive downlink channel. As illustrated in FIG. 4, a first video frame 1 is transmitted in the interval ta to tb, ending at time tb. At a time tc following time tb by no more than the SIFS interval, an audio frame 2 begins to be transmitted. The audio frame 2 ends at a time td. At a time te following time td by no more than the SIFS, transmission of a video frame 3 begins. The video frame 3 ends at a time tf. At a time tg no more than duration SIFS following time tf, an audio frame 4 begins. The audio frame 4 ends at a time th. The transmissions of the video and audio frames 1 through 4 in the time interval ta to th are separated by time intervals which are equal to SIFS, which is less than DIFS. Since the channel is never free in the sense that the interval between the frames is always less than DIFS, no user terminal receiving the channel can attempt to acquire the channel.

In FIG. 4, no actual video or audio information transmissions are made in the interval th to tk. This time includes a portion that exceeds the DIFS interval, so a user terminal could legitimately attempt to acquire control of the channel at some point during the interval ti through tj. According to an aspect of the invention, a dummy frame or null function 5, pursuant to the ANSI/IEEE standards, is transmitted beginning at a time ti, which is one SIFS later than the end of transmission of audio data at time th. The null function 5 continues until a time tj, which is one SIPS prior to time tk at which another video frame 6 becomes available for transmission. The transmission of the dummy or null frame 5 causes all the user terminals in the coverage area to interpret the access point as being busy for the entire period ta through tl. Consequently, no user terminal will attempt to access the medium, even though the broadcast of video or audio information on the exclusive downlink channel may cease on occasion.

While the illustration of FIG. 4 contemplates a time duration of SIFS between transmission of successive frames of information, any time which is less than DIFS can be used. One advantageous other time duration for the time between successive frames of broadcast information is the abovedescribed PIFS.

As mentioned above, the ANSI/IEEE standards provide for the transmission of NAV Duration information to the user terminals. The user terminals, according to the standards, should wait until the end of the NAV time to attempt to access the channel. The WLAN access point 230a of FIG. 2 could, in addition to using the dummy or null frame arrangement as described in conjunction with FIGS. 3 and 4, also transmit selected NAV information to the user terminals, indicating that the access point is continuously busy, such that the user terminals would not find any time in which access to the exclusive downlink channel would be permitted.

The arrangement according to the invention provides an exclusive downlink channel from the WLAN access point to the user terminals within its field of coverage with maximized quality of service (QoS) while operating in the DCF mode insofar as the QoS is affected by attempts to effect uplink traffic in the downlink channel. By disabling the uplink channel and traffic from the user terminal or station to the access point, a one-way one-to-many communication channel is established. This one-way channel can be used for video broadcast. Another advantage of the invention is that the method according to an aspect of the invention makes use only of functionality already provided by the communication standards, so there is no need for expensive retrofitting of equipment, and all user terminals receive the benefits of the invention. Put another way, the invention is compliant with the communication standards.

Thus, a method for broadcasting information according to an aspect of the invention comprises the steps of procuring (212) sequential frames of the information to be broadcast, and coupling the sequential frames of the information to a medium (230a, 250). The medium (230a, 250) comprises at least one access point (230a) of a local area network (230) conforming to communication standards (802.11) promulgated by a standards body (ANSI/IEEE). The information is transmitted to a coverage region (231) over a dedicated medium (one channel). The medium is shared, and access to the medium is based on carrier sense multiple access. The information is received at a user terminal (240) located in the coverage region (231) and compliant with the communication standards (ANSI/IEEE 802.11). As a result, during intervals in which the length of time between transmitted frames exceeds an Inter-Frame Space (DIFS) pursuant to the communication standards, the user terminal (240) can attempt to gain control of the channel. Frames are continuously broadcast from the at least one access point (230a) and on the channel, with the transmission of the frames having inter-frame times which are shorter than the Inter-Frame Spacing (DIFS) pursuant to the communication standards (ANSI/IEEE 802.11). This inhibits the attempt by the user terminal (230a) to gain control of the channel, whereby broadcasting of the information takes place without contention for control of the channel. In an advantageous mode of the method, the medium (230a, 250) includes a frequency channel of a wireless local area network.

A method for broadcasting information according to an aspect of the invention includes the steps of procuring (212) sequential frames of the information and coupling (220) the information to a medium (230, 250) comprising at least one access point (230a) of a wireless local area network (230) conforming to communication standards promulgated by a standards body (ANSI/IEEE 802.11). The information is for transmission to a coverage region (231) over a dedicated frequency band channel of the access point (230a). The medium (230, 250) is shared, and access to the medium is based on carrier sense multiple access. The information is received over the dedicated channel (230a, 250) at a user terminal (240), also compliant with the communication standards, and which is located in the coverage region (231). As a result, the user terminal (240) may attempt to gain control of the channel during intervals in which the length of time between transmitted frames of information exceeds an Inter-Frame Space (DIFS) according to the communication standards. Frames are continuously transmitted (FIG. 4) from the at least one access point (230a), and on the channel, with inter-frame gaps (SIFS or PIFS) which are shorter than the Inter-Frame Space (DIFS) according to the communication standards, whereby the user terminal (240) is inhibited from attempting to gain control of the channel (230a, 250), and broadcasting of the information occurs without contention for control of the channel (230a, 250).

In an exemplary embodiment of the method, the frames are transmitted by an access point operating in the DCF mode according to the IEEE 802.11 standards and the step of continuously transmitting frames includes the step of transmitting the frames with temporal spacing which is one of (a) Short Inter-Frame Space (SFIS) and (b) Point Inter-Frame Space (PIFS) as set forth in IEEE 802.11 communication standards. Operating in this manner, the mobile terminals in the WLAN according to the present invention need not read the PCF information in the beacon message in order for the access point to maintain control of the transmission channel. The step of procuring information may include procuring at least one of audio and video information, and preferably both

1. A method for broadcasting a video program in a wireless local area network to a plurality of mobile terminals, the method comprising the steps of:
receiving sequential frames of data representative of the video program from a signal source;
gaining access to a selected channel available within the wireless local area network in accordance with a communications standard associated with the wireless local area network, wherein access to the selected channel is based on carrier sense multiple access;
transmitting the sequential frames of data in the selected channel in accordance with the communications standard associated with the wireless local area network, the frames being separated by a predetermined inter-frame time period, the predetermined inter-frame time period being shorter than a first inter-frame time period defined by the communications standard that allows a device to gain control of the selected channel, whereby transmitting devices within the wireless local area network are inhibited from gaining control of the selected channel and the sequential frames of data can be continuously transmitted without interruption by another transmitting device within the wireless local area network.

2. The method according to claim 1, wherein the wireless local area network comprises a network in accordance with IEEE 802.11 standards operating in the distributed coordination function mode.

3. The method according to claim 2, wherein the predetermined inter-frame time period corresponds to the distributed inter-frame space.

4. The method according to claim 3, further comprising the step of adding a dummy frame in accordance with IEEE 802.11 standards to the sequential frames of data to maintain a desired inter-frame time period shorter than the Distributed inter-frame space.

5. The method according to claim 3, further comprising the step of adding null packet stuffing to desired ones of the frames of data to maintain a desired inter-frame time period shorter than the distributed inter-frame space.

6. The method according to claim 3, further comprising the step of detecting whether data to be transmitted corresponds to audio/video program data, and performing gaining and transmitting steps in response to the detection.

7. The method according to claim 3, further comprising the step of detecting the source of the sequential frames of data, and performing the gaining and transmitting steps in response to the detection of a particular source of the sequential frames of data.

8. The method according to claim 3, wherein the predetermined inter-frame time period corresponds to a short inter-frame space in accordance with IEEE 802.11 standards.

9. The method according to claim 3, wherein the predetermined inter-frame time period corresponds to a point inter-frame space in accordance with IEEE 802.11 standards.

10. An access point for transmitting audio/video program data in a wireless local area network wireless local area network, comprising:
means for receiving a sequence of data frames representative of the audio/video program;
means for detecting the availability of a transmission channel associated with the wireless local area network based on carrier sense multiple access in accordance with a communications standard associated with the wireless local area network;
means for gaining access to the transmission channel and for transmitting the sequence of data frames via the transmission channel, wherein transmitted data frames are separated by a predetermined inter-frame period that is shorted than a first inter-frame period defined by the communications standard that allows a transmitting device within the wireless local area network to gain control of the transmission channel, whereby the access point is able to transmit the sequence of data frames without interruption by another device in the wireless local area network.

11. The access point according to claim 10, wherein the wireless local area network comprises a network in accordance with IEEE 802.11 standards operating in the distributed coordination function mode.

12. The access point according to claim 11, wherein the predetermined inter-frame time period corresponds to the distributed inter-frame space.

13. The access point according to claim 12, wherein the transmitting means adds dummy frames in accordance with IEEE 802.11 standards to the sequence of data frames to maintain a desired inter-frame time period shorter than the distributed inter-frame space.

14. The access point according to claim 12, wherein the transmitting means adds null packet stuffing to desired ones of the data frames to maintain a desired inter-frame time period shorter than the distributed inter-frame space.

15. The access point according to claim 12, further comprising means for detecting whether data to be transmitted corresponds to audio/video program data, the transmitting means transmitting the sequence of data frames with the predetermined inter-frame time period in response to the detection.

16. The apparatus according to claim 12, further comprising means for detecting the source of the sequence of data frames, the transmitting means transmitting the sequence of data frames with the predetermined inter-frame time period in response to the detection of a particular source of the sequential frames of data.

17. The apparatus according to claim 12, wherein the predetermined inter-frame time period corresponds to a short inter-frame space in accordance with IEEE 802.11 standards.

18. The apparatus according to claim 12, wherein the predetermined inter-frame time period corresponds to a point inter-frame space in accordance with IEEE 802.11 standards.
